(19) United States
(12) Patent Application Publication
(10) Pub. No.: US 2025/0134139 A1
(43) Pub. Date: May 1, 2025

(54) A MIXED PROCESS AND SYSTEM FOR PREPARING A LIQUID OAT BASE OR DRINK FROM AN OAT DERIVED MATERIAL

(71) Applicant: OATLY AB, MALMÖ (SE)

(72) Inventors: David HELLBORG, MALMÖ (SE); Joakim BJUNÖ, MALMÖ (SE); Karin PETERSSON, MALMÖ (SE); Sofia EHLDE, MALMÖ (SE)

(21) Appl. No.: 18/726,068

(22) PCT Filed: Dec. 30, 2021
(86) PCT No.: PCT/EP2021/087832

§ 371 Date: Jul. 1, 2024

(51) Int. Cl. A23L 7/104; A23C 11/10; A23L 2/38

(52) U.S. Cl. CPC A23L 7/107; A23C 11/10; A23L 2/382

(57) ABSTRACT

The invention relates to a process for preparing a liquid oat base or drink from an oat derived material. The process comprises a first enzymation of the oat derived material, heating the oat derived material from the first enzymation to terminate the enzymation thereof, a second enzymation of the oat derived material from the heating. One of the first or second enzymation comprises filling a first enzymation tank with the oat derived material and enzymes, enzymating the oat derived material in the first enzymation tank, filling a second enzymation tank with the oat derived material and enzymes, the second enzymation tank being fluidly connected in parallel with the first enzymation tank, enzymating the oat derived material in the second enzymation tank, and producing a continuous flow of enzymised oat derived material by alternately emptying the first and second enzymation tanks. The other of the first or second enzymation comprises, simultaneously feeding an enzymation section with the oat derived material and enzymes, enzymating the oat derived material in the enzymation section, and outputting a flow of enzymated oat derived material from the enzymation section. The invention also relates to a system for preparing a liquid oat base or drink from an oat derived material.

### TECHNICAL FIELD OF THE INVENTION

The invention relates to a mixed process and system for preparing a liquid oat base or drink from an oat derived material.

### BACKGROUND

There is a growing interest in refraining from consumption of dairy products and from meat products, for example for health reasons, religious reasons, and sustainability reasons. In addition, there is a growing trend to choose products for consumption in the daily life which contribute to a positive climate impact. This may mean excluding or at least reducing intake of dairy based products as well as meat products.

Oat is well known for containing nutritious compounds and may be considered a sustainable vegetable ingredient in food production. Oat in different forms is therefore an often-used ingredient in healthy and nutritious foods.

For example, use of oats in production of oat-containing aqueous liquid, sometimes called an oat base, is well known. Such oat base may be used as ingredient or base for manufacturing of different food products, for example, analogues for dairy products. Oat beverage, such as an oat drink is one well known example.

Manufacturing of oat base, and oat drink, typically involves subjecting micronized oats to one starch degrading enzymatic treatment in aqueous suspension. Process parameters, such as temperature, have an effect on both enzymes and the micronized oats of the suspension. It is challenging and problematic during the manufacturing to maintain the micronized oats in the aqueous suspension, in a form suitable for the enzymatic treatment. It is further problematic to control the enzymatic activities, as well as maintaining nutritious qualities from the oats, during the manufacturing process.

There is, thus, a need for providing improved control of manufacturing process for the oat base, while at the same maintaining control of the quality of the oat base.

### SUMMARY OF INVENTION

It is an objective of the present invention to, at least partly, improve the overall process of preparing an oat base or drink.

According to a first aspect of the invention, these and other objects are achieved, in full or at least in part, by a process for preparing a liquid oat base or drink from an oat derived material. The process comprises a first enzymation of the oat derived material, heating the oat derived material from the first enzymation to terminate the enzymation thereof, a second enzymation of the oat derived material from the heating. One of the first or second enzymation comprises filling a first enzymation tank with the oat derived material and enzymes, enzymating the oat derived material in the first enzymation tank, filling a second enzymation tank with the oat derived material and enzymes, the second enzymation tank being fluidly connected in parallel with the first enzymation tank, enzymating the oat derived material in the second enzymation tank, and producing a continuous flow of enzymised oat derived material by alternately emptying the first and second enzymation tanks. The other of the first or second enzymation comprises, simultaneously feeding an enzymation section with the oat derived material and enzymes, enzymating the oat derived material in the enzymation section, and outputting a flow of enzymated oat derived material from the enzymation section. The invention also relates to a system for preparing a liquid oat base or drink from an oat derived material.

This is advantageous in that the process can run uninterruptedly. This provides for major cost-savings since the process will be automized and continuous.

In other words, the oat derived material may be subjected to two steps of enzymation. The first enzymation of the oat derived material may be a first enzymation of oat derived material in aqueous suspension, wherein a first enzymatically treated suspension is formed.

The heating of the oat derived material from the first enzymation to terminate the enzymation thereof, may be heating the first enzymatically treated suspension, wherein a heat-treated suspension is formed.

The second enzymation of the oat derived material from the heating may be a second enzymation of the heat-treated suspension, wherein a second enzymatically treated suspension is formed. The second enzymatically treated suspension, may, with or without further treatment, be an oat base or drink.

Thus, the second enzymation may, optionally, be followed by further treatment. The further treatment may be, for example, heating and/or removal of particulate matter or compounds, such as for example fiber residues or other non-desired matter originating from the oat derived material after the second enzymation. For example, the further treatment may be sedimentation, decantation, and/or filtering.

The process may further comprise cooling the oat derived material after the step of heating the oat derived material and before the step of the second enzymation of the oat derived material.

The process may further comprise the step of steaming the oat derived material after the step of heating the oat derived material to terminate the enzymation and before the step of cooling the oat derived material.

The process may further comprise the step of heating the oat derived material to terminate the enzymation thereof a second time after the step of the second enzymation of the oat derived material.

The process may further comprise the step of cooling the oat derived material a second time after the step of heating the oat derived material the second time.

The process may further comprise the step of steaming the oat derived material after the step of heating the oat derived material a second time and before the step of cooling the oat derived material the second time.

The oat derived material may comprise micronized oats or micronized oat-kernels, or oat-flour, or fractions of oat. For example, the oat derived material may, thus, be in form of milled, crushed or ground oat derived material, or a combination thereof. As another example, the fractions of oat may be oat bran or fiber reduced oat flour.

The oat derived material may be a mixture of oat and water. For example, the oat derived material may be a mixture of oat and water an aqueous or water-based suspension or slurry of one or more of micronized oat-kernels, oat-flour, and/or fractions of oat.

If the oat derived material comprises or is in form of micronized oats or micronized oat-kernels, or oat-flour, or fractions of oat, the oat derived material may be oat derived material provided for or entering the first enzymation. Such oats, for example micronized oats, will in the process be at least partially degraded or transformed, for example by means of the first and second enzymation, and it shall be understood that as it progresses in the process it may cease to be in the provided form of micronized oats or oat-kernels.

The oat derived material may be selected from heat-treated wet milled oats, heat-treated dry milled oats, heat-treated oat bran, heat-treated dehulled or hulled/naked dry milled oat flour.

The oat derived material may be provided as an aqueous or water suspension, slurry or paste. Thereby, the oat derived material can be pumped and mixed and efficiently subjected to heating. Further, such oat derived material may be efficiently enzymatically treated. The content of oat derived material in water may be, for example, 5-30% by weight dry substance, such as 10-25% by weight dry substance based on the weight of the oat derived material in water.

The oat derived material comprising oat starch may be subjected to a partial hydrolysis by a starch degrading enzyme, such as amylase. The amylase may be one or more of α-amylase and β-amylase.

The oat derived material comprising proteins may be subjected to a protein solubilizing enzyme such as a protein deamidase, preferably protein glutaminase.

A desirable and synergistic effect, which improves levels of solubilized proteins, is achievable from the combination of using starch degrading enzymes and protein solubilizing enzymes. Enzymation of the product in two separate steps will make it possible to provide a product with a more even quality.

After the first enzymation the oats may be subjected to higher temperatures of the heating. This is believed to be, at least in part, a result of starch degradation in the first enzymation, which results in lower degree of gelatinization during the heat treatment as compared to heat treatment without a preceding first enzymation.

Other enzymes for solubilizing proteins may be used than the protein deamidase or protein glutaminase. Solubilization of proteins, as used herein, is intended to describe an increase of solubility of the proteins in water or aqueous liquid as compared to prior to or without the treatment, such that at least a portion of the proteins present in the oat derived material may be provided in aqueous or water solution. Solubilization may be realized, for example, by enzymes modifying amino acids of the proteins, such as side chains of amino acids, into more hydrophilic form, for example by converting amide groups of the side chains. Any type of enzymes suitable for this purpose in providing an oat base or oat drink may be considered for the purpose. Converting the proteins into a more water-soluble form, or solubilizing proteins, allows for more efficient process for preparing a liquid oat base or drink from an oat derived material, as well as improved properties of the oat base or drink. Increase solubility may, for example, improve extraction of proteins from an oat derived material matrix during the process, thus increasing levels of oat protein in the oat base or drink.

The first and/or the second enzymation may comprise contacting the oat derived material with protein solubilizing enzyme, preferably protein deamidase such as protein glutaminase.

According to a second aspect of the invention, these, and other objects, and/or advantages that will be apparent from the following description, are achieved, in full or at least in part, by a system for preparing a liquid oat base or drink from an oat derived material. The system comprises a first enzymation section adapted for a first enzymation of the oat derived material, a heating device fluidly connected to and arranged downstream of the first enzymation section and adapted to heat the oat derived material from the first enzymation, and a second enzymation section fluidly connected to and arranged downstream of the heat changer and adapted for a second enzymation of the oat derived material from the heating device. The first or second enzymation section comprises at least two enzymation tanks fluidly connected in parallel, the at least two enzymation tanks being configured to produce a continuous flow of enzymised oat derived material. The other of the first or second enzymation section has a continuous infeed and outfeed and comprises a volume, which is selected such that the oat derived material is enzymised during a predetermined time-period.

The heating device may be adapted to both heat the oat derived material in a first step and thereafter cool the oat derived material in a second step.

The heating device may comprise a heat exchanger and/or a steam injector.

The system may further comprise a second heating device fluidly connected to and arranged downstream of the second enzymation section and adapted to heat the oat derived material a second time.

The second heating device may be adapted to both heat the oat derived material in a first step and thereafter cool the oat derived material in a second step.

The heating device may comprise a heat exchanger and/or a second steam injector.

The first enzymation section and/or the second enzymation section may comprise a conduit or a reservoir, such as a tank, respectively.

Effects and features of the second aspect of the present invention are largely analogous to those described above in connection with the first aspect of the inventive concept. Examples mentioned in relation to the first aspect of the present invention are largely compatible with the further aspects of the invention.

Other objectives, features and advantages of the present invention will appear from the following detailed disclosure, from the attached claims, as well as from the drawings. It is noted that the invention relates to all possible combinations of features.

Generally, all terms used in the claims are to be interpreted according to their ordinary meaning in the technical field, unless explicitly defined otherwise herein. All references to “a/an/the [element, device, component, means, step, etc.]” are to be interpreted openly as referring to at least one instance of the element, device, component, means, step, etc., unless explicitly stated otherwise.

The oat base or drink material may comprise, by dry weight, 5-20% protein, and 3-15% fat, and optionally 10-80% carbohydrates, including sugars. Typically, the oat base or oat drink may comprise sugars 2-8%, fibers 0.2-3% (out of which 0.1-1% of the oat drink are beta glucans), fat 0.0-2.5%, and proteins 0.5-2.5%, by weight of the oat base or drink. The liquid oat base or drink may comprise an oat derived material with 5-20% by weight dry substance, based on the weight of the liquid oat base or drink.

Herein is disclosed a process for preparing the liquid oat base or drink from the oat derived material. It shall be understood that the oat derived material changes in the process. In the present disclosure, in an attempt to improve understanding and clarity of the disclosure, the term oat derived material is sometimes used to describe and refer to oat derived material having undergone different treatment in the process, and, thus, one oat derived material may not be the same as another oat derived material. Sometimes herein, if deemed to improve clarity, the term oat derived material is further specified, for example, by defining it as an oat derived material from the first enzymation, or an oat derived material from the heating etc. Some examples of changes, which the oat derived material may undergo in the process, will now be given. Oat derived material in the first enzymation and the second enzymation may, for example, be subjected to starch degrading enzymes, which enzymes may degrade starch present in the oat derived material and, thus, change the oat derived material. As a further example, the heating the oat derived material may involve swelling of starch in the oat derived material, thus changing the oat derived material. To further exemplify, oat derived material early in the first enzymation may be micronized oat kernels with essentially intact starch, while oat derived material at the end of the first enzymation may be oat derived material comprising degraded starch.

The oat base or drink from the process may be mixed with additional additives and may then be referred to a liquid oat composition.

Herein is disclosed a process for preparing the liquid oat base or drink from the oat derived material by contacting the oat derived material with the enzyme such as the starch degrading enzyme, and the protein solubilizing enzyme. It shall be understood that the contact may be performed in many different ways such as for example by mixing the oat derived material and the enzyme in a supply or vessel such as a tank and/or a pipe. The mixing may be performed by any known mixing techniques such as in a mixing tank comprising impellers or blades.

As used herein, the term “comprising”, and variations of that term are not intended to exclude other additives, components, integers, or steps.

### BRIEF DESCRIPTION OF THE DRAWINGS

The above, as well as additional objects, features, and advantages of the present invention, will be better understood through the following illustrative and non-limiting detailed description of examples of the present invention, with reference to the appended drawings, where the same reference numerals may be used for similar elements, and wherein:

FIGS. 1A and 1B are flow charts of examples of a process for preparing a liquid oat base or drink from an oat derived material.

FIGS. 1C and 1D are flow charts of two examples of sub-steps to the process for preparing a liquid oat base or drink from an oat derived material the examples shown in FIG. 1A or 1B.

FIG. 2 is a schematic view of one example of a system for preparing a liquid oat base or drink from an oat derived material.

FIG. 3 is a schematic view of another example of a system for preparing a liquid oat base or drink from an oat derived material.

FIG. 4 is a schematic view of a heating device in a system for preparing a liquid oat base or drink from an oat derived material.

FIG. 5a-5c are schematic views of further examples of a system for preparing a liquid oat base or drink from an oat derived material.

FIG. 6a-6c are schematic views of further examples of a system for preparing a liquid oat base or drink from an oat derived material.

### DETAILED DESCRIPTION

The present inventive concept will now be described more fully hereinafter with reference to the accompanying drawings, in which currently preferred variants of the inventive concept are shown. This inventive concept may, however, be implemented in many different forms and should not be construed as limited to the variants set forth herein; rather, these variants are provided for thoroughness and completeness, and fully convey the scope of the present inventive concept to the skilled person.

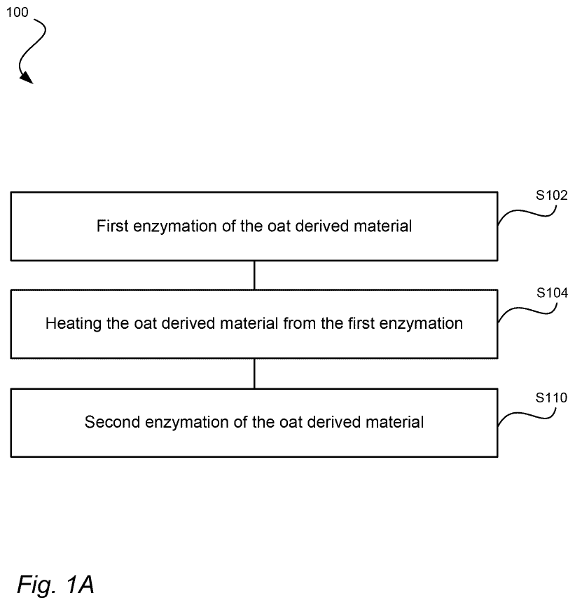

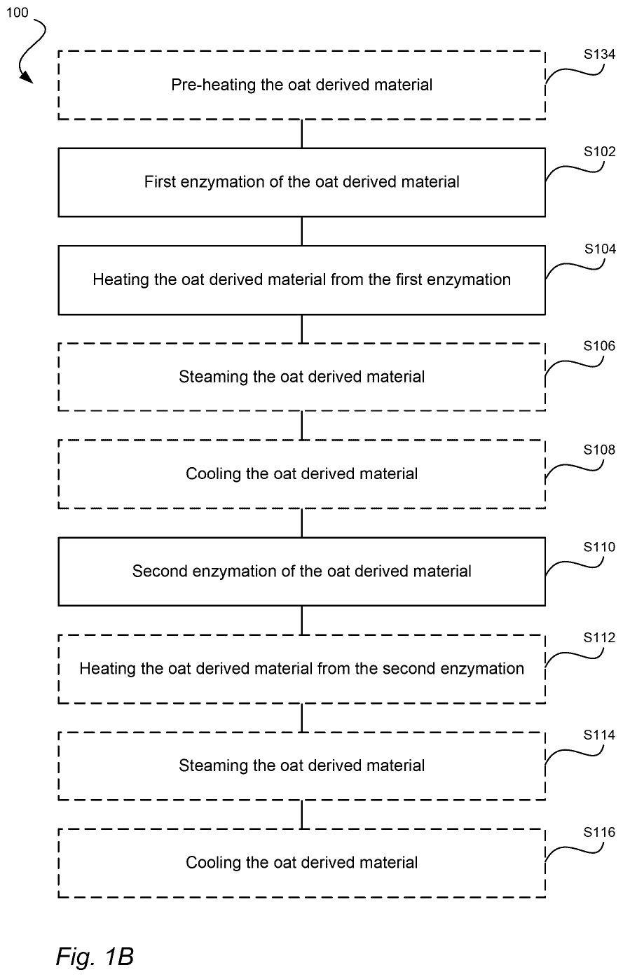

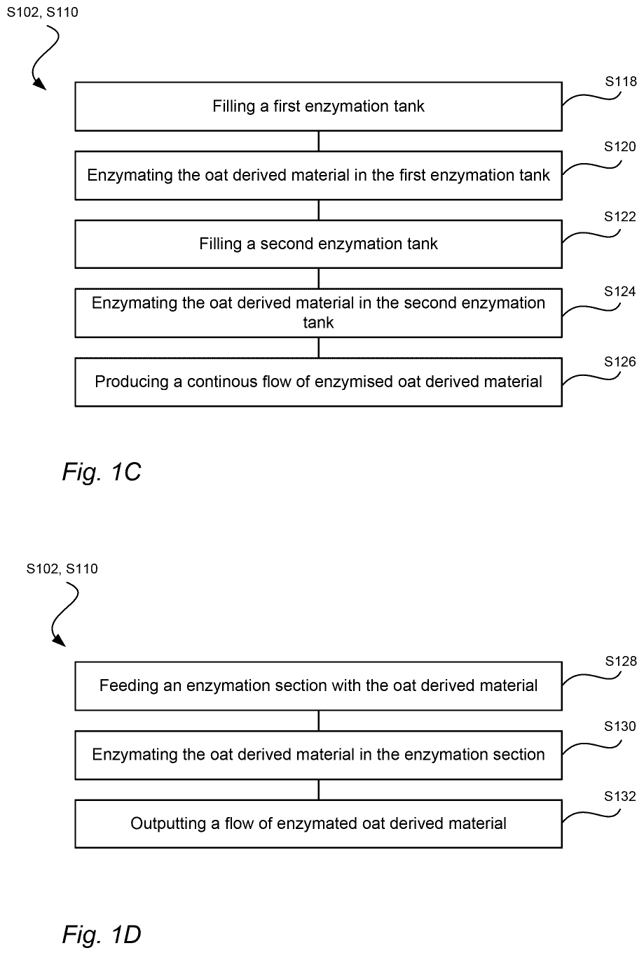

FIG. 1A is a flow chart illustrating the steps of an example of a process 100 for preparing a liquid oat base or drink from an oat derived material. Below, different steps are described in more detail and the steps of the process 100 may be performed multiple times and starting with a first enzymation S102 of the oat derived material. The oat derived material may comprise micronized oats or micronized oat-kernels, or oat-flour. The oat derived material may be provided as an aqueous or water suspension or slurry. The first enzymation S102 may comprise contacting the oat derived material with a starch degrading enzyme. The starch degrading enzyme may preferably be amylase. Alternatively, or in addition, the first enzymation S102 may comprise contacting the oat derived material with a protein solubilizing enzyme. The protein solubilizing enzyme may preferably be protein deamidase such as protein glutaminase. Oat derived material which has been subject to any degree of enzymation may also be referred to as enzymised oat derived material.

After the first enzymation S102 has been performed for a desired time, such as for example 30-90 minutes, preferably, 50-70 minutes, the oat derived material from the first enzymation S102 is heated S104 to terminate the enzymation thereof. The heating process may be such that the enzymation is either completely terminated or partly terminated. The heating process may have the effect of making the oat derived material more susceptible to enzymes. In other words, the oat derived material may be more accessible for enzymation.

For example, the heating of the oat derived material may gelatinize starch present in the oat derived material and allow swelling of starch and swelling of any present oat derived material granules, thereby providing open oat derived material. Open oat derived material may also be referred to as open oat particles, swelled starch, or hydrated starch.

It shall be understood that as oat derived material is treated in the process, for example by enzymes acting on the oat derived material, or the oat derived material being heated, the oat derived material typically changes, for example resulting from depletion of starch from the oat derived material. Oat derived material having undergone, for example the first enzymation S102, may therefore, herein, be referred to as oat derived material from the first enzymation S102, to differentiate it from e.g., oat derived material provided before the first enzymation S102. Oat derived material which has been subject to any degree of enzymation may alternatively be referred to as enzymised oat derived material.

Following the step of heating S104, a second enzymation S110 of the oat derived material from the heating S104 is performed. The second enzymation S110 may comprise contacting the oat derived material with starch degrading enzymes. The starch degrading enzyme may preferably be amylase. Alternatively, or in addition, the second enzymation S110 may comprise contacting the oat derived material with protein solubilizing enzyme. The protein solubilizing enzyme may preferably be protein deamidase or protein glutaminase.

From the discussion above, it is clear that a number of different combinations of enzymes are possible in the first and second enzymations S102, S110 for a duration of time such as for example 30-90 minutes, preferably, 50-70 minutes and which will be further discussed below.

In on example, the first enzymation S102 and the second enzymation S110 may be performed in the same way. For example, both the first enzymation S102 and the second enzymation S110 may comprise using starch degrading enzymes. Alternatively, both the first enzymation S102 and the second enzymation S110 may comprise using protein solubilizing enzymes. Even though the same enzyme may be used, a ratio between oat derived material and enzyme of the respective enzymation may be different. For example, more enzyme may be added in the first enzymation than the second enzymation or the opposite. Similarly, a time period in which the oat derived material is enzymised in the first enzymation S102 and the second enzymation S110 respectively may be different.

As another example, the enzymation in the first and/or second enzymation S102, S110 may comprise using both the starch degrading enzyme and the protein solubilizing enzymes.

The first enzymation S102 and the second enzymation S110 may be performed in different ways. For example, the first enzymation S102 may comprise using starch degrading enzyme while the second enzymation S110 may comprise using protein solubilizing enzymes. Further, the ratio between enzyme and oat derived material in the respective enzymation may be different, as well as the time-period in which the oat derived material is enzymised.

The first enzymation S102 and the second enzymation S104 comprises different sub-steps which are described in connection to FIG. 1C and 1D.

FIG. 1B is a flow chart illustrating the steps of the process for preparing a liquid oat base or drink from an oat derived material as described above in connection with FIG. 1A but with some optional additional steps. Below, the different steps are described in more detail. Even though illustrated in a specific order, the steps of the process 100 may be performed in any suitable order, as well as multiple times and in parallel.

The oat derived material may be cooled S108. The cooling S108 of the oat derived material may be performed after the heating S104 of the oat derived material and before the second enzymation S110 of the oat derived material. In other words, the heated enzymised oat derived material from the first enzymation S102 may be cooled S108.

The oat derived material may be steamed S106. The steaming S106 of the oat derived material may be performed after the heating S104 of the oat derived material and before the cooling S108 of the oat derived material. In other words, the enzymised oat derived material may be injected with steam to increase the heat of the oat derived material. Thus, further terminating the enzymation.

The oat derived material may be heated S112 a second time. The second heating S112 may be performed after the second enzymation S110 of the oat derived material. Put differently, the enzymised oat derived material from the second enzymation S112 may be heated to terminate the enzymation thereof. The second heating S112 of the enzymised oat derived material may cause the enzymation of the oat derived material to be terminated to a higher degree than the first heating S104.

The oat derived material may be cooled S116 a second time. The second cooling S116 of the oat derived material may be performed after the second heating S112 of the oat derived material. In other words, the heated enzymised oat derived material from the second enzymation S110 may be cooled S116.

The oat derived material may be steamed S114 a second time. The second steaming S114 of the oat derived material may be performed after the second heating S112 of the oat derived material and before the second cooling S116 of the oat derived material. In other words, the enzymised oat derived material may be injected with steam to increase the heat of the oat derived material. Thus, further terminating the enzymation of the second enzymation S110.

In an alternative, the oat derived material may be heated in a pre-heating step S134, before the first enzymation S102. The heat treatment of the oat derived material in the pre-heating step S134 may be milder than the first and/or second heating S104, S112. In other words, the oat derived material may be heated to a lower temperature during the pre-heating S134, than during the first and second heating S104, S112.

FIG. 1C is a flow chart illustrating one example of steps of enzymating the oat derived material.

A first enzymation tank is filled S118 with the oat derived material and enzymes.

The oat derived material in the first enzymation tank is enzymated S120.

A second enzymation tank is filled S122 with the oat derived material and enzymes. The second enzymation tank being fluidly connected in parallel with the first enzymation tank.

The oat derived material in the second enzymation tank is enzymated S124.

A continuous flow of enzymised oat derived material is produced S126 by alternately emptying the first and second enzymation tanks. More specifically, the steps of filling and enzymating one of the enzymation tanks may be performed while the other tank is emptied of enzymised oat derived material and vice versa.

FIG. 1D is a flow chart illustrating another example of steps of enzymating the oat derived material.

An enzymation section is fed S128 with the oat derived material and enzymes.

The oat derived material in the enzymation section is enzymated S130.

A flow of enzymated oat derived material is outputted S132 from the first enzymation section.

The steps of feeding S128 the enzymation section, enzymating S130 the oat derived material in the enzymation section and outputting S132 a flow of enzymised oat derived material is performed simultaneously. In other words, the enzymation section is continuously fed with new oat derived material and at the same time continuously outputting enzymated oat derived material. Thus, the oat derived material is enzymated during the time which it flows through the enzymation section.

The time which the oat derived material flows through the enzymation section may be such that the oat derived material is enzymated to a predetermined enzymation level. Put differently, the time it takes from when the oat derived material enters the enzymation section to when the oat derived material exits the enzymation section may be the same as an enzymation time te, where the enzymation time te is the time it takes for the oat derived material to be enzymised to the predetermined level.

The first enzymation S102 of the oat derived material may comprise the sub-steps of FIG. 1C while the second enzymation S110 comprises the sub-steps of FIG. 1D. Alternatively, the first enzymation S102 of the oat derived material may comprise the sub-steps of FIG. 1D, while the second enzymation S110 comprises the sub-steps of FIG. 1C.

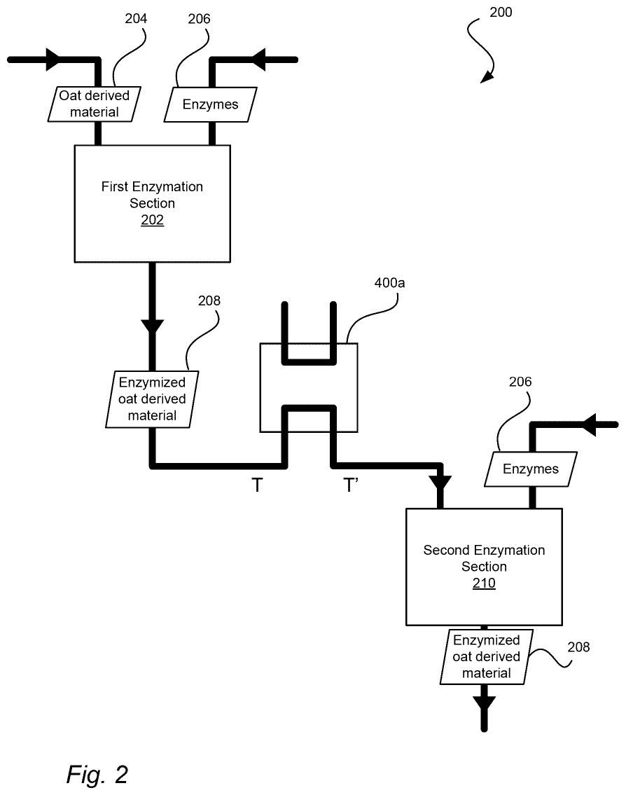

FIG. 2 schematically illustrates one example of the system 200 for preparing a liquid oat base or drink from an oat derived material 204.

The system 200 may comprise a first enzymation section 202. The first enzymation section 202 may be adapted for a first enzymation of the oat derived material. The first enzymation section 202 may thus be configured to receive the oat derived material 204 and enzyme 206. Put differently, the first enzymation section 202 may be fluidly connected to a supply (not shown) of oat derived material. Further, the first enzymation section 202 may be fluidly connected to a supply (not shown) of enzymes. The enzyme 206 may be added to the oat derived material 204 prior to entering the first enzymation section 202. Thus, the first enzymation section 202 may have one inlet.

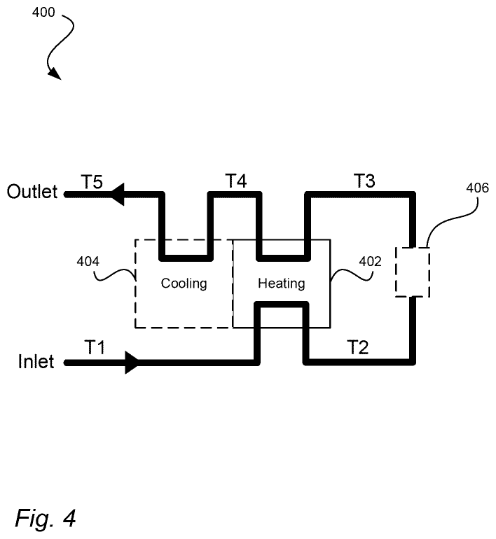

The first enzymation section may output enzymised oat derived material 208. The system 200 may further comprise a heating device 400a. The heating device 400a may be fluidly connected to the first enzymation section 202. The heating device 400a may be arranged downstream from the first enzymation section 202. Thus, the heat exchanger 400a may receive the enzymised oat derived material 208 outputted from the first enzymation section 202. The heating device 400a may heat the oat derived material 208 form the first enzymation section 202. The heating device 400a may heat the oat derived material from a first temperature T to a second temperature T′. The heating device 400a may heat the oat derived material to terminate the enzymation process. The heating device 400a is further described in connection to FIG. 4.

The system may further comprise a second enzymation section 210. The second enzymation section 210 may be fluidly connected to the heating device 400a. The second enzymation section 210 may be arranged downstream of the heating device 400a. The second enzymation section 210 may be adapted for a second enzymation of the enzymised oat derived material 208. The second enzymation section 210 may thus be configured to receive oat derived material from the heating device 400a and enzyme from a supply of enzyme (not shown). Even though the inlet of the enzyme 206 is illustrated as separate from the enzymised oat derived material, they may be combined. Put differently, the enzyme 206 may be mixed with the oat derived material prior to entering the second enzymation section 210.

The second enzymation section 210 may output enzymised oat derived material. The enzymised oat derived material outputted form the second enzymation section 210 may be enzymised to a higher degree than the enzymised oat derived material outputted from the first enzymation section 202. Alternatively, the enzymised oat derived material outputted from the second enzymation section 210 may be enzymised in a different way from the enzymised oat derived material outputted from the first enzymation section 202.

It shall be realized and appreciated that the illustration of FIG. 1 is a simplified view for illustrative purposes. Other components may be part of the system 200 as well, which would be apparent to the skilled person, even though not illustrated. For example, valves, sensors, pipe connections etc.

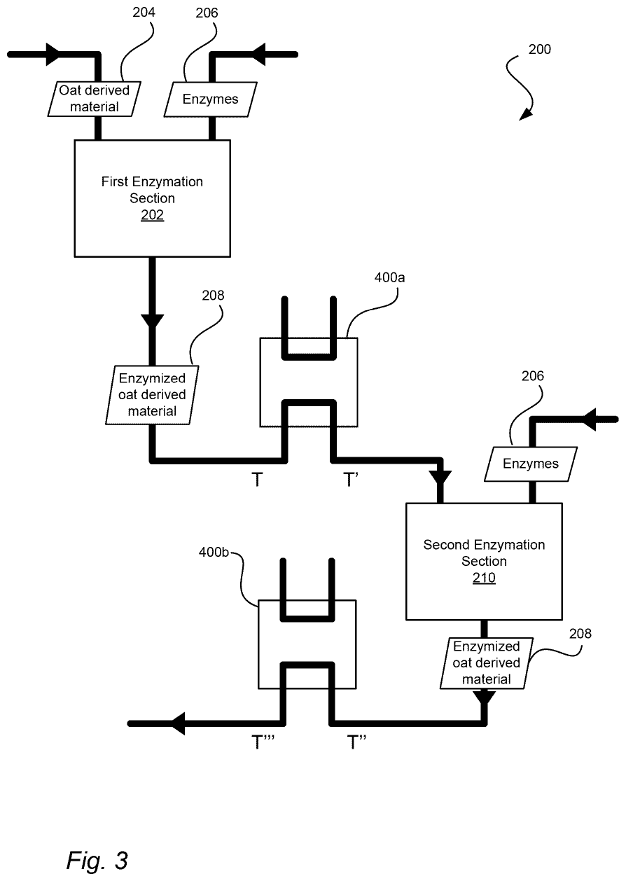

FIG. 3 schematically illustrates another example of the system 200 for preparing the liquid oat base or drink from the oat derived material.

In addition to what is described in connection to FIG. 2, the example of the system 200 illustrated herein may further comprise a second heating device 400b. The second heating device 400b may be fluidly connected to the second enzymation section 210. The second heating device 400b may be arranged downstream from the second enzymation section 210. The second heating device 400b may be adapted to heat the oat derived material a second time. The oat derived material may be heated from a third temperature T″ to a fourth temperature T′″.

FIG. 4 schematically illustrates the heating device 400 in the system for preparing the liquid oat base or drink from the oat derived material. The heating device 400 illustrated herein may thus constitute the first heating device 400a and/or second heating device 400b illustrated in FIG. 2 and FIG. 3. The heating device may change the temperature of the oat derived material from a temperature T1 to a temperature T5. The temperature T5 may be higher than the temperature T1. Alternatively, the temperature T5 may be the same as the temperature T1. Alternatively, the temperature T5 may be lower than the temperature T1.

The heating device 400 may comprise a heat exchanger 402. The heat exchanger 402 may increase the temperature of the oat derived material from the temperature T1 to a temperature T2. The heat exchanger 402 may further heat the oat derived material a second time from a temperature T3 to a temperature T4. The heating device may further comprise a cooling section 404. The cooling section 404 may be a part of the heat exchanger 402. Thus, the heating device 400 may be adapted to both heat the oat derived material and cool the oat derived material. The cooling section 404 may reduce the temperature of the oat derived material from the temperature T4 to the temperature T5. Thus, even though the temperature T1 of the inputted oat derived material may be the same as, or lower than, the temperature T5 of the outputted oat derived material, the oat derived material may still have been heated to a higher temperature as some point thus terminating the enzymation of the oat derived material.

The heating device 400 may further comprise a steam injector 406. The steam injector 406 may be connected to the heat exchanger 402 and arranged downstream from the heat exchanger 402. The steam injector 406 may be adapted to steam the oat derived material, thus increasing the temperature of the oat derived material from the temperature T2 to the temperature T3.

As illustrates herein, the heat exchanger 402 may be arranged to exchange heat between the oat derived material before the steam injector 406 and the oat derived material after the steam injector 406. This may be advantageous in that heat energy produced by the steam injector can be re-used in the heating of the oat derived material from the temperature T1 to the temperature T2, thus saving energy. Further, the oat derived material from the steam injector 406 can be cooled from the temperature T3 to the temperature T4, thus reducing the amount of cooling needed by the cooling section 404.

The heating device 400 is not limited to comprising a heat exchanger and/or steam injector. The heating device 400 may be any device suitable for the cause. For example, the heating device 400 may comprise a device for heating the oat derived material by using microwaves. The heating device 400 may be an immersion heater. The heating device may comprise tubular heating elements. The heating device 400 may be a circulation heater. The heating device 400 may be an electrode heater.

The cooling section 404 may be a heat exchanger connected to a cooling medium.

The heating process may take approximately 5-10 minutes. The time of the heating process in the first and second heating device may be different.

The temperatures T1-T5 may be different in the first heating device 400a and the second heating device 400b.

For example, in the first heating device 400a, the temperature T5 may be 60 degrees C. The temperature T5 may correspond to the second temperature T″ as illustrated in FIG. 2. The temperature T3 may be 110 degrees C.

For example, in the second heating device 400b, the temperature T5 may be 5 degrees C. The temperature T5 may in this case correspond to the fourth temperature T′″ as illustrates in FIG. 3. The temperature T3 may be 90 degrees C.

Temperature T1 may be 55 to 65 degrees, or more preferably 60 degrees. Temperature T2 may be 75 to 85 degrees, or more preferably 80 degrees. Temperature T3 may be 85 to 95 degrees, or more preferably 90 degrees. Temperature T4 may be 65 to 75 degrees, or more preferably 70 degrees. Temperature T5 may be 55 to 65 degrees, or more preferably 60 degrees.

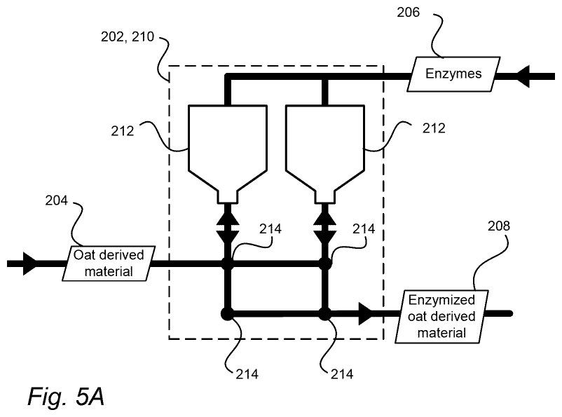

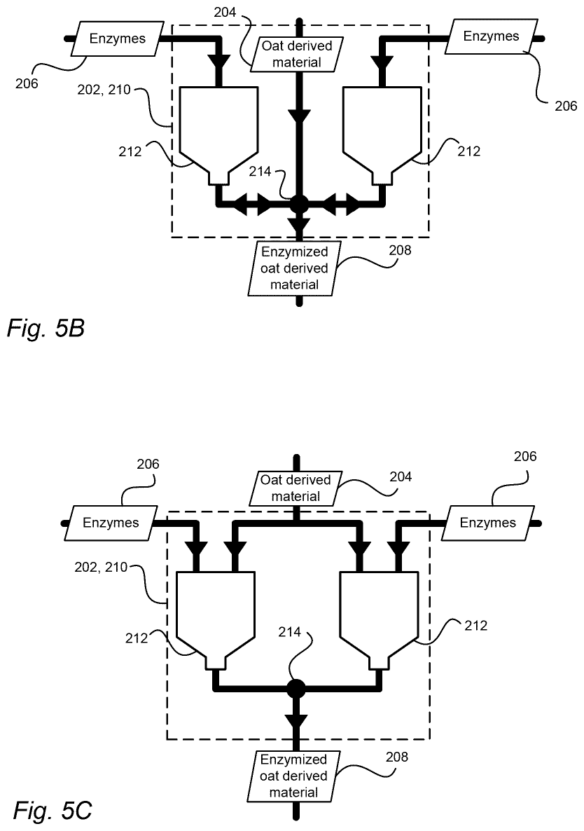

FIG. 5a schematically illustrates one further example of the system 200 for preparing a liquid oat base or drink from an oat derived material. More particularly, it illustrates one exemplary configuration of the first and second enzymation sections 202, 210.

The first or second enzymation section 202, 210 may comprise two enzymation tanks 212. The first or second enzymation section 202, 210 may comprise more than two enzymation tanks 212. The at least two enzymation tanks 212 may be fluidly connected in parallel. The at least two enzymation tanks 212 may be configured to produce a continuous flow of enzymised oat derived material 208. In this illustration, the two enzymation tanks 212 are connected by connection points 214 which may comprise valves, such that one of the enzymation tanks 212 may be emptied, while the other enzymation tank 212 is filled with the oat derived material 204 and enzyme 206 or while the enzymation is taking place. More specifically, the at least two enzymation tanks 212 may each have a volume V, a filling time t1 and an emptying time t2. The enzymation tank 212 with volume V may have an enzymation time te. A continuous outflow of enzymised oat derived material 208 can thus be achieved by setting the emptying time t2 equal to the filling time t1 and enzymation time te together. Thus, one of the at least two enzymation tanks 212 can be emptied while the other one of the at least two enzymation tanks 212 are filled with new oat derived material and enzyme and enzymating the oat derived material filled in the enzymation tank. When one of the at least two enzymation 212 tanks has been emptied, the two enzymation tanks 212 can switch so that the now empty enzymation tank is filled with new oat derived material to be enzymised while the other enzymation tank is being emptied. The total time for filling t1, enzymating te and emptying t2 one enzymation tank may be approximately one hour. The volume V of the enzymation tanks 212 may be 10 000-14 000 L. Alternatively, the volume V of the enzymation tanks 212 may be 6 000 L-14 000L.

In this example, the enzyme 206 and the oat derived material 204 are filled into the enzymation tanks 212 in separate pipes. The inlet for the oat derived material 204 may be the same as the outlet for the enzymised oat derived material 208. The inlet for the oat derived material 204 and the outlet for the enzymised oat derived material 208 may comprise a number of product pipes connected in a number of connection points 214, herein illustrated as four connection points. The connection points 214 may be controlled by one or more valves. The connection points 214 may for example be T-connections or Y-connections. The four connection points 214 may allow for one of the enzymation tanks 212 to be filled, while the other enzymation tank 212 is emptied, without interfering with each other.

FIG. 5b illustrates another example of an enzymation section having two tanks 212 fluidly connected in parallel as illustrated in FIG. 5a.

Different from FIG. 5a is that only a single connection point 214 fluidly connects the flow of oat derived material 204 and enzymised oat derived material 208. Even though not illustrated, the enzyme 206 may be supplied from the same supply of enzymes. The connection point 214 may comprise one or more valves for controlling the flow to the two enzymation tanks 212.

FIG. 5c illustrates yet another example of an enzymation section having two tanks 212 fluidly connected in parallel as illustrated in FIGS. 5a and 5b.

In this example, the inlet of enzyme 206 and oat derived material 204 are separated from the outlet of enzymised oat derived material 208. A connection point 214 connects the outlet of the enzymation tanks 212. Even though the inlet of the enzyme 206 and the oat derived material 204 are illustrates as being separate, they may be mixed prior to the enzymation tanks 212 such that the enzymation tanks 212 only have one inlet each.

It should be realized that the illustrations in FIGS. 5a to 5c are non-limiting examples which are simplified for illustrative purposes. The scale and size of the different components may not be representative of the reality. Further, points where the product lines connect to the enzymation tanks 212 are not limited to those illustrates herein. For example, even though a line is illustrates as connecting at the top of the enzymation tank 212, it may connect to the enzymation tank 212 at other points as well.

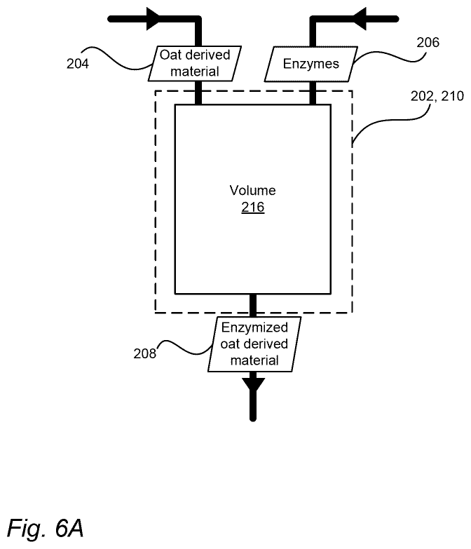

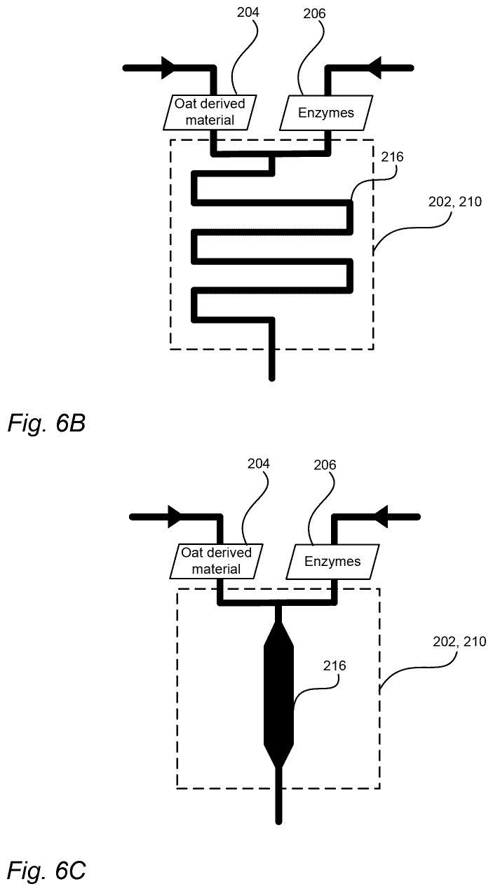

FIG. 6a schematically illustrates one further example of the system 200 for preparing a liquid oat base or drink from an oat derived material. More particularly, it illustrates another exemplary configuration of the first and second enzymation sections 202, 210 in contrast to those illustrated in FIGS. 5a to 5c.

The first or second enzymation section 202, 210 may have a continuous infeed and outfeed. The first or second enzymation section 202, 210 may comprise a volume 216. The volume 216 being selected such that the oat derived material 204 is enzymised during a predetermined time-period.

The volume 216 and a flow rate of the oat derived material 204 flowing through the volume 216 may be selected such that the time-period in which the oat derived material 204 is enzymised in the volume 216 yields a satisfactory enzymation. Put differently, the volume 216 may be such that the oat derived material 204 is present in the enzymation section 202, 210 during enough time for the oat derived material to be enzymised, i.e., equal to the enzymation time te. In other words, during the time it takes from that the oat derived material 204 enters the enzymation section 202, 210 to that the oat derived material exits the enzymation section 202, 210 as enzymised oat derived material 208, the oat derived material has been enzymised to the satisfactory level. For this, also the flow rate of the oat derived material may be considered. The satisfactory enzymation may be reaching a predetermined level of enzymation. The predetermined level of enzymation may be that the oat derived material 204 has reached a desired viscosity. Alternatively, the predetermined level of enzymation may be that the oat derived material 204 is only partly enzymised.

FIG. 6b illustrates another example of an enzymation section 202, 210 having a volume 216 with a continuous infeed and outfeed as illustrated in FIG. 6a. The volume 216 is herein illustrated as an increased pathway for the oat derived material 204 and enzyme 206 to travel through the enzymation section 202, 210. In other words, the length of the processing pipes in the enzymation section 202, 210 may be set such that the time it takes for the oat derived material 204 to travel through the enzymation section 202, 210 allows for the satisfactory enzymation.

FIG. 6c illustrates yet another example of an enzymation section 202, 210 having a volume 216 with a continuous infeed and outfeed as illustrated in FIGS. 6a and 6b. The volume 216 is herein illustrated as a section of the processing pipe having an increased cross-sectional area. This may cause the flow rate of the oat material 204 to decrease through the volume 216 of the enzymation section 202, 210. Thus, allowing the oat derived material 204 to be in the enzymation section 202, 210 a sufficient amount of time for reaching the satisfactory enzymation level.

In other words, the first enzymation section 202 may be configured as illustrated by way of example in FIGS. 5a to 5c, while the second enzymation section 210 may be configured as illustrates by way of example in FIGS. 6a to 6c. Alternatively, the first enzymation section 202 may be configured as illustrated by way of example in FIGS. 6a to 6c, while the second enzymation section 210 may be configured as illustrates by way of example in FIGS. 5a to 5c.

Reference is hereby made to a number of related applications with the same applicant and filing date as the present application. A related application titled A TWO-STEP PROCESS AND SYSTEM FOR PREPARING A LIQUID OAT BASE OR DRINK FROM AN OAT DERIVED MATERIAL discloses a process and system for preparing a liquid oat base or drink from an oat derived material in a two-step enzymation process for a higher throughput. Another related application titled A BATCH PROCESS AND SYSTEM FOR PREPARING A LIQUID OAT BASE OR DRINK FROM AN OAT DERIVED MATERIAL discloses a process and system for preparing a liquid oat base or drink from an oat derived material where the first and second enzymation sections comprises two or more enzymation tanks respectively for a higher output. Another related application titled A CONTINUOUS PROCESS AND SYSTEM FOR PREPARING A LIQUID OAT BASE OR DRINK FROM AN OAT DERIVED MATERIAL discloses a process and system for preparing a liquid oat base or drink from an oat derived material where the first and second enzymation sections comprises a first and second volume respectively with continuous inlet and outlet for a higher throughput.

It is understood that other variations in the present invention are contemplated and, in some instances, some features of the invention can be employed without a corresponding use of other features. Accordingly, it is appropriate that the appended claims be construed broadly in a manner consistent with the scope of the invention.

1. A process (100) for preparing a liquid oat base or drink from an oat derived material, comprising:
a first enzymation (S102) of the oat derived material,
heating (S104) the oat derived material from the first enzymation to terminate the enzymation thereof,
a second enzymation (S110) of the oat derived material from the heating, and
wherein one of the first or second enzymation (S102, S110) comprises:
filling (S118) a first enzymation tank with the oat derived material and an enzyme,
enzymating (S120) the oat derived material in the first enzymation tank,
filling (S122) a second enzymation tank with the oat derived material and an enzyme, the second enzymation tank being fluidly connected in parallel with the first enzymation tank,
enzymating (S124) the oat derived material in the second enzymation tank, and
producing (S126) a continuous flow of enzymised oat derived material by alternately emptying the first and second enzymation tanks,
wherein the other of the first or second enzymation (S102, S110) comprises, simultaneously:
feeding (S128) an enzymation section with the oat derived material and enzyme,
enzymating (S130) the oat derived material in the enzymation section, and
outputting (S132) a flow of enzymated oat derived material from the enzymation section.

2. The process (100) according to claim 1, further comprising cooling (S108) the oat derived material after the step of heating (S104) the oat derived material and before the step of the second enzymation (S110) of the oat derived material.

3. The process (100) according to claim 2, further comprising the step of steaming (S106) the oat derived material after the step of heating (S104) the oat derived material to terminate the enzymation and before the step of cooling (S108) the oat derived material.

4. The process (100) according to claim 1, further comprising the step of heating (S112) the oat derived material to terminate the enzymation thereof a second time after the step of the second enzymation (S110) of the oat derived material.

5. The process (100) according to claim 4, further comprising the step of cooling (S116) the oat derived material a second time after the step of heating (S112) the oat derived material the second time.

6. The process (100) according to claim 4, further comprising the step of steaming (S114) the oat derived material after the step of heating (S112) the oat derived material a second time and before the step of cooling (S116) the oat derived material the second time.

7. The process (100) according to claim 1, wherein the oat derived material comprises micronized oats or micronized oat-kernels, or oat-flour, or fractions of oat.

8. The process (100) according to claim 1, wherein the oat derived material is provided as an aqueous or water suspension or slurry.

9. The process (100) according to claim 1, wherein the first and/or the second enzymation (S102, S110) comprises contacting the oat derived material with a starch degrading enzymes, preferably amylase.

10. The process (100) according to claim 1, wherein the first and/or the second enzymation (S102, S110) comprises contacting the oat derived material with a protein solubilizing enzyme, preferably protein deamidase such as protein glutaminase.

11. A system (200) for preparing a liquid oat base or drink from an oat derived material (204), comprising:
a first enzymation section (202) adapted for a first enzymation of the oat derived material (204),
a heating device (400a) fluidly connected to and arranged downstream of the first enzymation section (202) and adapted to heat the oat derived material (208) from the first enzymation, and
a second enzymation section (210) fluidly connected to and arranged downstream of the heating device (400a) and adapted for a second enzymation of the oat derived material (208) from the heating device (400a), and
wherein the first or second enzymation section (202, 210) comprises at least two enzymation tanks (212) fluidly connected in parallel, the at least two enzymation tanks (212) being configured to produce a continuous flow of enzymised oat derived material (208),
wherein the other of the first or second enzymation section (202, 210) has a continuous infeed and outfeed and comprises a volume (216), the volume (216) being selected such that the oat derived material is enzymised during a predetermined time-period.

12. The system (200) according to claim 11, wherein the heating device (400a) is adapted to both heat the oat derived material in a first step and thereafter cool the oat derived material in a second step.

13. The system (200) according to claim 11, wherein the heating device (400a) comprises a heat exchanger (402) and/or a steam injector (406).

14. The system (200) according to claim 11, further comprising a second heating device (400b) fluidly connected to and arranged downstream of the second enzymation section (210) and adapted to heat the oat derived material (208) a second time.

15. The system (200) according to claim 14, wherein the second heating device (400b) is adapted to both heat the oat derived material in a first step and thereafter cool the oat derived material in a second step.

16. The system (200) according to claim 14, wherein the second heating device (400b) comprises a heat exchanger (402) and/or a second steam injector (406).

17. The system (200) according to claim 11, wherein the first enzymation section (202) and/or the second enzymation section (210) comprises a conduit or a reservoir, such as a tank, respectively.
